(19) United States
(12) Patent Application Publication
(10) Pub. No.: US 2025/0078422 A1
(43) Pub. Date: Mar. 6, 2025

(54) SYSTEM, METHOD, NON-TRANSITORY RECORDING MEDIUM, AND DISPLAY DEVICE

(71) Applicants: Tsuyoshi MAEHANA, Kanagawa (JP); Haseo HOTTA, Kanagawa (JP); Koki HIGASHI, Kanagawa (JP)

(72) Inventors: Tsuyoshi MAEHANA, Kanagawa (JP); Haseo HOTTA, Kanagawa (JP); Koki HIGASHI, Kanagawa (JP)

(21) Appl. No.: 18/784,923

(22) Filed: Jul. 26, 2024

(30) Foreign Application Priority Data
Aug. 31, 2023 (JP) 2023-140810
May 27, 2024 (JP) 2024-085376

(51) Int. Cl. G06T 19/00; G06T 19/20

(52) U.S. Cl. CPC G06T 19/006; G06T 19/20; G06T 2210/62; G06T 2219/2004

(57) ABSTRACT

A system includes circuitry to generate display data in which a three-dimensional model and an image captured are superimposed, perform alignment to align a position of an object included in the three-dimensional model and a position of a subject included in the image captured, capture a superimposed image in which the position of the object included in the three-dimensional model and the position of the subject included in the captured image are aligned by the alignment, and project the captured superimposed image on a virtual sphere for display.

### CROSS-REFERENCE TO RELATED APPLICATIONS

This patent application is based on and claims priority pursuant to 35 U.S.C. § 119(a) to Japanese Patent Application Nos. 2023-140810, filed on Aug. 31, 2023, and 2024-085376, filed on May 27, 2024, in the Japan Patent Office, the entire disclosure of which is hereby incorporated by reference herein.

### BACKGROUND

### Technical Field

The present disclosure relates to a system, a method, a non-transitory recording medium, and a display device.

### Related Art

With the development of information processing technology, methods for displaying stereoscopic images have diversified. For example, a method of superimposing a three-dimensional computer graphic image on an image obtained by capturing an actual object to compare the actual object with a three-dimensional model is known.

There is a technique for displaying an image of a three-dimensional model superimposed on a real image following a change in the relative position of the field of view.

A subject in the field of view of an imaging device and a virtual three-dimensional computer graphics image can be displayed as if they were integrated.

### SUMMARY

According to one or more aspects, a system includes circuitry to generate display data in which a three-dimensional model and an image captured are superimposed, perform alignment to align a position of an object included in the three-dimensional model and a position of a subject included in the image captured, capture a superimposed image in which the position of the object included in the three-dimensional model and the position of the subject included in the captured image are aligned by the alignment, and project the captured superimposed image on a virtual sphere for display.

According to one or more aspects, a method includes generating display data in which a three-dimensional model and an image captured are superimposed, performing alignment to align a position of an object included in the three-dimensional model and a position of a subject included in the image, and capturing a superimposed image in which the position of the object included in the three-dimensional model and the position of the subject included in the image are aligned by the alignment. The captured superimposed image is to be projected on a virtual sphere for display.

According to one or more aspects, a display device includes circuitry to acquire a captured superimposed image in which a position of an object included in a three-dimensional model and a position of a subject included in an image are aligned and project and display the captured superimposed image on a display.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an overall hardware configuration of a display system according to some embodiments;

FIG. 2 is a sectional view of an imaging device included in a display system according to some embodiments;

FIGS. 3A to 3D are block diagrams each illustrating a hardware configuration of a device included in a display system according to some embodiments;

FIG. 4 is a block diagram illustrating software included in a display system according to some embodiments;

FIGS. 5A to 5C are diagrams illustrating an example of superimposing a wide-field image on an image of a three-dimensional model according to some embodiments;

FIG. 6A is a diagram illustrating a head-mounted display (HMD) worn by a user on his or her head according to some embodiments;

FIG. 6B is a diagram illustrating an example of an image displayed on an HMD according to some embodiments;

FIGS. 7A and 7B are diagrams each illustrating an example of a superimposed image viewed from the inside of a virtual sphere according to some embodiments;

FIGS. 8A to 8C are diagrams illustrating an example of alignment according to some embodiments;

FIGS. 9A to 9D are diagrams illustrating an example of cases where a viewpoint is moved after alignment in the related art;

FIG. 10 is a flowchart illustrating a process performed by a display system according to some embodiments;

FIGS. 11A to 11C are diagrams illustrating an example of displaying a captured image according to some embodiments; and

FIGS. 12A to 12C are diagrams illustrating an example of changing the transparency of an image projected on a virtual sphere according to some embodiments.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Some embodiments of the present disclosure are described below. However, the present disclosure is not intended to be limited to the embodiments described herein. In the drawings referred to below, the same or similar reference codes are used for the common or corresponding components, and redundant descriptions are omitted as appropriate. In the following embodiments, a wide-field image having a wide viewing angle such as a 360-degree image (may be referred to as a spherical image, a panoramic image, or an omnidirectional image) obtained by capturing the entire 360-degree circumference is described as an example. However, the embodiments are not limited thereto, and for example, a super-wide-angle panoramic image or an image obtained by capturing the entire 360° circumference of a horizontal plane may be used.

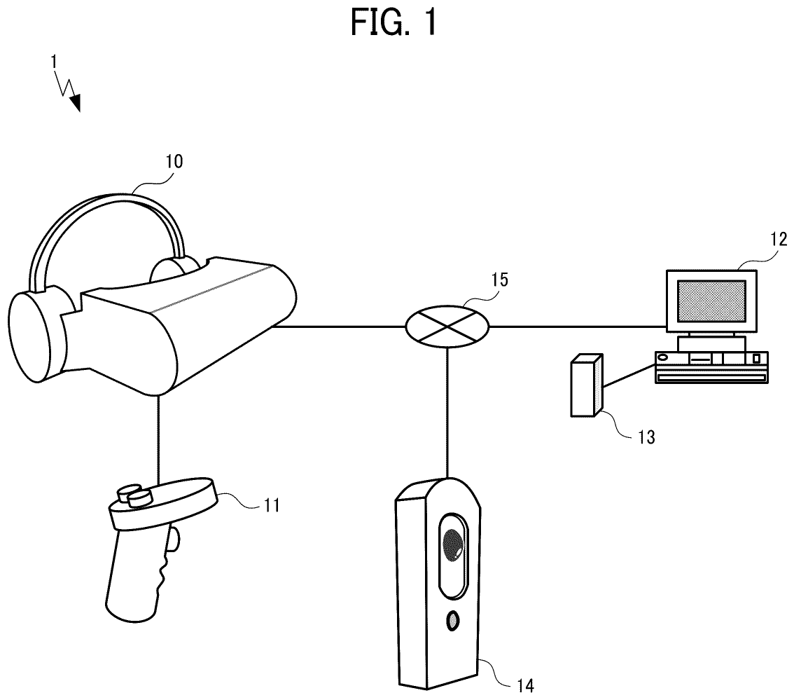

FIG. 1 is a schematic diagram illustrating a hardware configuration of a display system 1 according to an embodiment of the present disclosure. The display system 1 includes a head-mounted display (HMD) 10 functioning as a display device mounted on the head of a user, a controller 11 functioning as an operation device operated by the user while being held by a hand or mounted on the hand, and a personal computer (PC) 12 that is an example of an information processing apparatus. The display system 1 further includes a position detection sensor 13 that functions as a detection unit for detecting the position of the HMD 10 and the tilt of the HMD 10 relative to the reference direction, and the position of the controller 11 and the tilt of the controller 11 relative to the reference direction. The display system 1 further includes an imaging device 14 for imaging a wide-field image.

The HMD 10, the controller 11, the PC 12, and the imaging device 14 are communicably connected to each other via such as a network 15, a cable. The hardware components may be connected by a wired connection or a wireless connection such as BLUETOOTH (registered trademark) or WIFI (registered trademark). The HMD 10 and the position detection sensor 13 may be wirelessly connected to each other by WIFI (registered trademark). The PC 12 and the imaging device 14 may exchange the image data by various recording media in addition to or in alternative to the wired or wireless communication as described above.

The HMD 10 is a display device that includes a display for displaying an image to a user and displays an image corresponding to the position of the HMD 10 or the tilt relative to a reference direction on the display. The image includes two images corresponding to the left and right eyes so that the image looks three-dimensional using the binocular disparity of the user. For this reason, the HMD 10 includes two displays for displaying images corresponding to the left and right eyes. The reference direction is, for example, any direction parallel to the floor. The HMD 10 includes a light source such as an infrared light-emitting diode (LED) and emits infrared radiation.

The controller 11 is an operation device held by a hand of the user or worn on a hand of the user and includes a button, a wheel, and a touch sensor. The controller 11 receives an input of information from the user and transmits the received information to the HMD 10. The controller 11 also includes a light source such as an infrared LED that emits infrared radiation. The controller 11 illustrated in FIG. 1 is a type that is held by a user's hand, but the embodiments are not limited to this. For example, the controller 11 may be in the form of a glove including a sensor.

The position detection sensor 13 is positioned at a desired location in front of the user, detects the position and the tilt relative to the reference direction of the HMD 10 and the position and the tilt relative to the reference direction of the controller 11 from the infrared radiation emitted from the HMD 10 and the controller 11, respectively, and outputs the position information and the tilt information. The position detection sensor 13 is, for example, an infrared camera, and can detect the position and tilt of the HMD 10 and the position and tilt of the controller 11 based on an image captured by the imaging device 14.

The number of light sources of each of the HMD 10 and the controller 11 is multiple to detect the positions and tilts of the HMD 10 and the controller 11 with high accuracy. The position detection sensor 13 includes one or more sensors. In a case where the position detection sensor 13 includes multiple sensors, for example, one or more of the multiple sensors can be arranged on the right side, the left side, or the rear side in addition to on the front side of the position detection sensor 13.

The PC 12 generates a user object to assist the user in performing an input operation in a three-dimensional virtual space displayed on the display of the HMD 10 based on the position information and the tilt information of the HMD 10 and the position information of the controller 11, which are output from the position detection sensor 13. The tilt information of the controller 11 may be additionally used to generate the user object as appropriate. The PC 12 generates an image (image corresponding to the left and right eyes) in the user's field of view direction in the three-dimensional virtual space (more precisely, the tilt direction of the HMD 10) based on the position information and the tilt information of the HMD 10 and the display data of a three-dimensional virtual space displayed on the HMD 10, and cause the display of the HMD 10 to display the image. The PC 12 can also create three-dimensional models of various structures. A three-dimensional model created by the PC 12 is output as image data and can be displayed on the HMD 10.

In another preferred embodiment, the display system 1 may include a server as an alternative to the PC 12. That is, in some embodiments, the display system 1 may execute processing performed by the PC 12 in the present embodiment on the cloud and provide a service.

The imaging device 14 captures multiple wide-angle lens images or multiple fisheye lens images. The imaging device 14 captures an image with a solid angle of 4π steradians centered around the imaging device 14 (in the following description, the image may be referred to as a “wide-field image”). The detailed configuration of the imaging device 14 is described later.

The display system 1 according to the present embodiment can display a wide-field image and an image of a three-dimensional model in a superimposed manner. For example, when a three-dimensional model of an internal structure of a building to be constructed is compared with an internal structure of an actually constructed building in the field of architecture, a wide-field image is captured in the building and an image of the three-dimensional model is superimposed and displayed. By so doing, the image can be used to check whether a structure conforming to the three-dimensional model is constructed. This is one mode of use, and the present disclosure is not limited to this mode of use. For example, the present disclosure is applicable to a medical field by displaying an internal structure, such as an organ, a skeleton, or a brain, of a human body or by surgical simulation, or also applicable to other fields.

In the example illustrated in FIG. 1, each of the HMD 10 and the controller 11 includes a light source, and the position detection sensor 13 is positioned at a desired location. However, this is not limiting, and each of the HMD 10 and the controller 11 may include the position detection sensor 13, and a marker that reflects a light source or infrared radiation may be positioned at a desired position. In a case where the marker is used, each of the HMD 10 and the controller 11 is provided with a light source and the position detection sensor 13, the infrared radiation emitted from the light source is reflected by the marker, and the reflected infrared is detected by the position detection sensor 13. Accordingly, the positions and tilts of the HMD 10 and the controller 11 can be detected. In another preferred embodiment, each of the HMD 10 and the controller 11 may include an inertial sensor such as a gyro sensor or an accelerometer to detect the corresponding movement of the HMD 10 and the controller 11.

When there is an object between the position detection sensor 13 and the HMD 10 or the controller 11, the infrared radiation is blocked, and the position and the tilt are not accurately or successfully detected. To deal with this, operations and displays performed using the HMD 10 and the controller 11 are preferably performed in an open space.

In the example illustrated in FIG. 1, a space is provided so that the user wearing the HMD 10 and holding the controller 11 in his or her hand can stretch or extend his or her arms, and the PC 12 and the position detection sensor 13 are positioned outside the space.

In the description of the present embodiment, the HMD 10 is used as an example of a display device. However, the embodiments of the present disclosure are not limited thereto. For example, the image may be displayed using a display device other than the HMD 10 such as a flat panel display (FPD) or a display 47 (described later) of the PC 12.

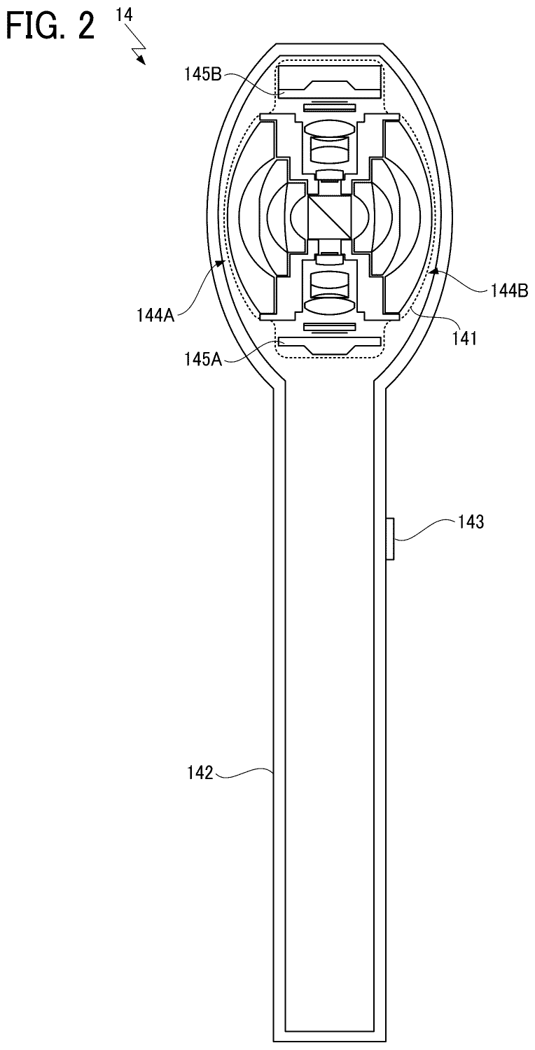

FIG. 2 is a cross-sectional view of the imaging device 14 included in the display system 1 according to the present embodiment. The imaging device 14 illustrated in FIG. 2 includes an imaging body 141, a casing 142 that holds the imaging body 141, and other components such as a control board and a battery, and an imaging button 143 arranged on the casing 142. The imaging device 14 further includes various sensors such as an acceleration sensor and a ground magnetic sensor and devices such as a communication interface (I/F). One or more of the above-described components allow the imaging device 14 to obtain orientation data or transfer an image to the PC 12.

The imaging body 141 illustrated in FIG. 2 includes two lens optical systems 144A and 144B and two image sensors 145A and 145B. The image sensors 145A and 145B are, for example, complementary metal oxide semiconductor (CMOS) sensors, or charge-coupled device (CCD) sensors. The image sensors 145A and 145B are arranged so that the imaging surfaces thereof are opposed to each other. Each of the lens optical systems 144A and 144B is configured as a fisheye lens consisting of, for example, seven lenses in six groups or fourteen lenses in ten groups. In the present embodiment illustrated in FIG. 2, the fisheye lens has a full angle of view of 180 degrees or more (=360 degrees/n, where n denotes the number of optical systems and n is 2), preferably has an angle of view of 190 degrees or more. In the description of the present embodiment, two fisheye lenses each having a full angle of view of 180 degrees or more are used. In some embodiments, three or more lens optical systems and imaging elements may be used as long as a predetermined angle of view is obtained as a whole. In the description of the present embodiment, a fisheye lens is used. In some embodiments, as long as a predetermined angle of view is obtained as a whole, a wide-angle lens or super-wide-angle lens may be used as an alternative to the fisheye lens.

The relative positions of the optical elements (lenses, prisms, filters, and aperture stops) of the two lens optical systems 144A and 144B are defined with reference to the image sensors 145A and 145B. More specifically, positioning is made such that the optical axis of the optical elements of each of the lens optical systems 144A and 144B is positioned at the central part of the light-receiving area of corresponding one of the image sensors 145 orthogonally to the light-receiving area, and such that the light receiving area serves as the imaging plane of corresponding one of the fisheye lenses. In the present embodiment described below, in order to reduce disparity, a bending optical system in which light collected by the two lens optical systems 1144A and 144B is distributed to the two image sensors 145A and 145B by two 90-degree prisms is used. However, the present disclosure is not limited thereto. In some embodiments, a three-fold refracting structure is adopted in order to further reduce disparity. In some embodiments, a straight optical system is adopted in order to reduce cost.

In the present embodiment illustrated in FIG. 2, the lens optical systems 144A and 144B have the same specification and are combined facing opposite such that the optical axes thereof match with each other. The image sensors 145A and 145B convert the light distribution of the received light into an image signal and sequentially output images to the image processing block of the control board. As described below in detail, the images captured by the image sensors 145A and 145B are stitched together, resulting in the generation of a wide-field image. The wide-field image is an image obtained by capturing all directions that can be seen from an imaging point. The wide-field image may be obtained as a still image or a moving image.

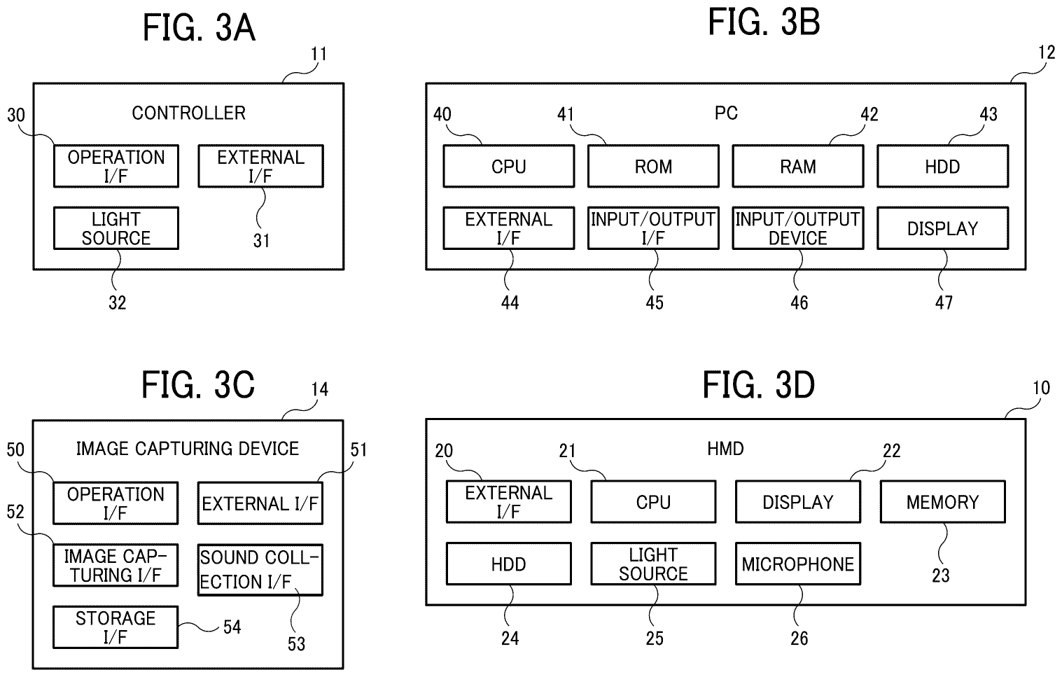

FIGS. 3A to 3D are diagrams each illustrating a hardware configuration of a device included in the display system 1 according to the present embodiment. The HMD 10 includes an external I/F 20, a central processing unit (CPU) 21, a display 22, a memory 23, a hard disk drive (HDD) 24, a light source 25, and a microphone 26. The CPU 21 controls the entire HMD 10 and performs processing such as light emission of the light sources 25, communication with the outside, and display on the display 22. The external I/F 20 is an interface for communicating with the PC 12.

The display 22 may be a liquid crystal display or an organic electro luminescence (EL) display.

The memory 23 provides a working area for the CPU 21. The HDD 24 stores, for example, the display data of a three-dimensional virtual space to be displayed on the HMD 10. The light source 25 is, for example, an infrared LED and emits infrared. The infrared radiation may be emitted in a predetermined pattern of flashing. The microphone 26 is a voice input device that performs user input by voice.

The controller 11 includes an operation I/F 30, an external I/F 31, and a light source 32. The operation I/F 30 includes a button, a wheel, and a touch sensor, arranged on the outer surface of the controller 11, enables an operation by a user, and receives an input of operation information. The external I/F 31 is wirelessly connected to the PC 12 and transmits the operation information received by the operation I/F 30 to the PC 12. The light source 32 emits infrared radiation in a predetermined pattern of flashing. The light source 32 emits infrared radiation in a predetermined pattern of flashing that is different from the light sources of the HMD 10, and thus the infrared radiation emitted from the controller 11 is distinguished from that emitted from the HMD 10.

The PC 12 includes a CPU 40, a read-only memory (ROM) 41, a random access memory (RAM) 42, an HDD 43, an external I/F 44, an input/output I/F 45, an input device 46, and the display 47.

The CPU 40 controls the entire PC 12, generates a user object, generates an image in the user's field of view direction in a three-dimensional virtual space displayed on the HMD 10, and executes processing for displaying the image on the display of the HMD 10. The ROM 41 stores, for example, a boot program for activating the PC 12, firmware for controlling the HDD 43 and the external I/F 44. The RAM 42 provides a working area for the CPU 40.

The HDD 43 stores, for example, an operating system (OS) and a program for executing the above-described processing. The external I/F 44 is connected to the network illustrated in FIG. 1 and communicates with other devices via the network. The external I/F 44 is connected to the HMD 10 and the position detection sensor 13 by, for example, a cable, is wirelessly connected to the controller 11, and communicates with the HMD 10, the controller 11, and the position detection sensor 13.

The input device 46 is, for example, a mouse or a keyboard and receives input of information and operations from the user. The display 47 provides a display screen to the user and displays, for example, information input by the user and a processing result. The input/output I/F 45 is an interface that controls input of information from the input device 46 and the output of information to the display 47.

The imaging device 14 includes an operation I/F 50, an external I/F 51, an imaging I/F 52, a sound collection I/F 53, and a storage I/F 54.

The operation I/F 50 is an interface for operating the imaging device 14, and may be various buttons or switches. The user can perform execution of imaging of a wide-field image and data transmission and reception by operating the imaging device 14 via the operation I/F 50.

The external I/F 51 is an interface for communicating with other devices, and may be a network communication interface such as a network interface card (NIC) or a port for connecting various connectors such as a universal serial bus (USB). The imaging device 14 can communicate with other devices included in the display system 1 directly via the network 15 or indirectly without via the network 15, by using the external I/F 51.

The imaging I/F 52 is an interface for capturing a wide-field image via the imaging body 141.

The sound collection I/F 53 is an interface for recording sound together with an image when a moving image is captured. The sound collection I/F 53 may be a microphone, and in some embodiments, may include multiple microphones.

The storage I/F 54 is an interface for storing a captured wide-field image. The wide-field image may be stored in a storage device such as a ROM included in the imaging device 14 or may be stored in an external storage device such as a secure digital (SD) card.

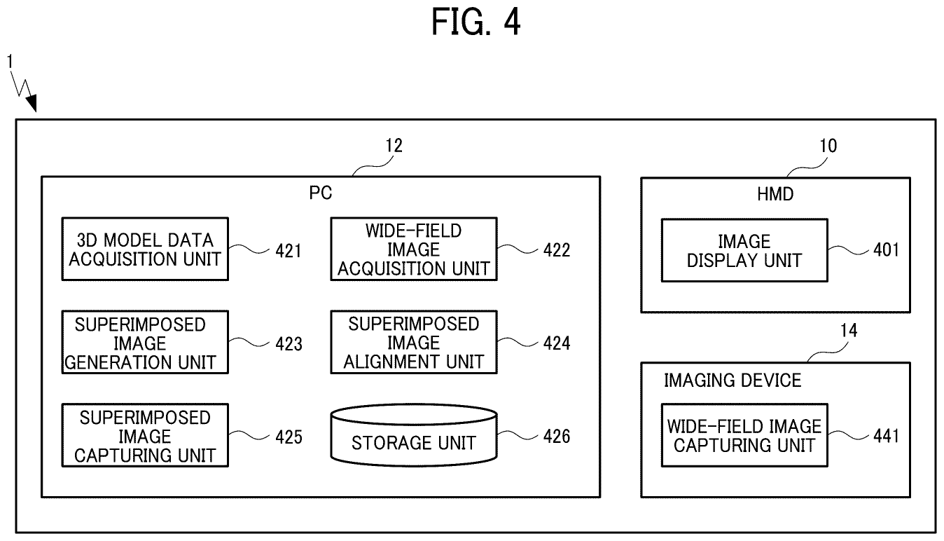

The hardware configuration included in each device included in the display system 1 according to the present embodiment has been described above. Functional units executed by one or more of the hardware components according to the present embodiment are described below with reference to FIG. 4.

FIG. 4 is a block diagram of software provided for the display system 1 according to the present embodiment. As illustrated in FIG. 4, the display system 1 according to the present embodiment includes the PC 12 that includes a three-dimensional model data acquisition unit 421, a wide-field image acquisition unit 422, a superimposed image generation unit 423, a superimposed image alignment unit 424, a superimposed image capturing unit 425, and a storage unit 426. The HMD 10 includes an image display unit 401, and the imaging device 14 includes a wide-field image capturing unit 441. The functional units are described in detail below.

Functional units included in the PC 12 are described below. The three-dimensional model data acquisition unit 421 is a unit that acquires data of a three-dimensional model, namely three-dimensional model data. The three-dimensional model data acquisition unit 421 according to the present embodiment can acquire three-dimensional model data from, for example, the storage unit 426.

In the embodiment described below, the three-dimensional model may be a building information model (BIM) representing the internal structure of a building, but the present disclosure is not particularly limited thereto.

The wide-field image acquisition unit 422 is a unit that acquires a wide-field image captured by the imaging device 14. The wide-field image acquisition unit 422 according to the present embodiment may acquire a wide field-of-view image by receiving the wide field-of-view image from the imaging device 14 via the network 15, or may acquire a wide field-of-view image from the storage unit 426.

The wide-field image acquired by the wide-field image acquisition unit 422 may be a still image or a moving image.

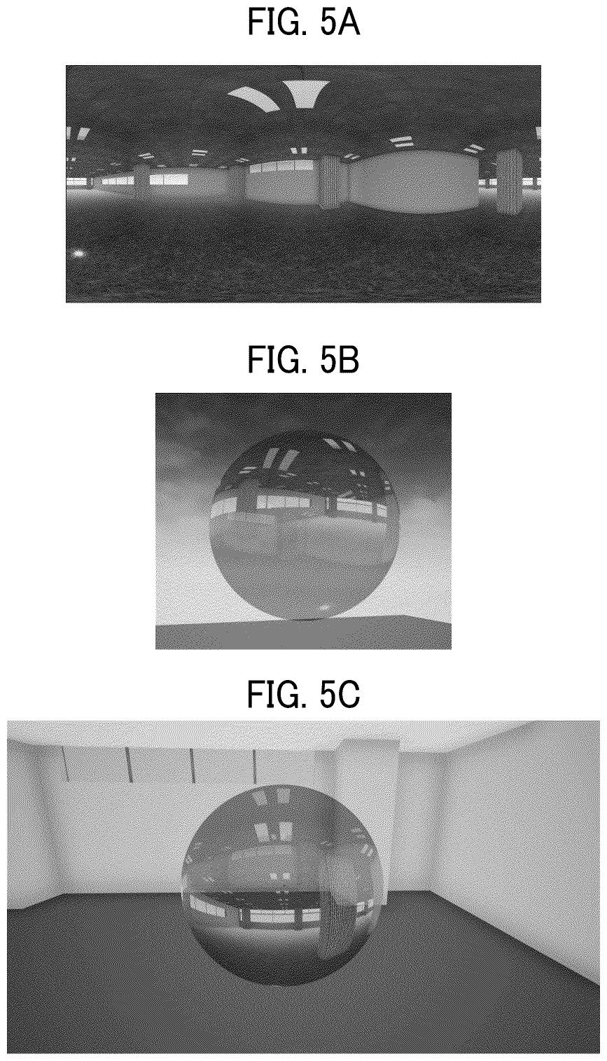

The superimposed image generation unit 423 is a unit that generates an image (superimposed image) by superimposing a three-dimensional model acquired by the three-dimensional model data acquisition unit 421 and a wide-field image acquired by the wide-field image acquisition unit 422. The superimposed image generation unit 423 according to the present embodiment may generate superimposed display data for displaying a superimposed image. Superimposing an image performed by the superimposed image generation unit 423 according to the present embodiment is described below with reference to FIG. 5.

FIGS. 5A to 5C are diagrams illustrating an example of superimposing a wide-field image on a three-dimensional model in the present embodiment.

FIG. 5A is an example of a wide-field image, and in the example, an image of an indoor space of a building captured by the imaging device 14 is illustrated. The wide-field image can be projected onto a virtual sphere as illustrated in FIG. 5B. By arranging such a sphere in the space of a three-dimensional model as illustrated in FIG. 5C, the wide-field image can be superimposed on the three-dimensional model. That is, by arranging the viewpoint position in the sphere and displaying the wide-field image projected on the sphere with constant transparency, the wide-field image can be displayed as an image superimposed on the three-dimensional model.

The superimposed image generation unit 423 according to the present embodiment can generate a superimposed image as illustrated in FIG. 5C.

In the example of the superimposition illustrated in FIGS. 5A to 5C, the example in which the sphere on which the wide-field image is projected is arranged in the three-dimensional model has been described, but the embodiment is not particularly limited. For example, a sphere on which a three-dimensional model is projected may be arranged in a spherical image, and the spherical image and the three-dimensional model may be superimposed. Alternatively, a three-dimensional model with adjustable transparency may be arranged in a spherical image, so that the spherical image and the three-dimensional model are superimposed on each other.

Referring again to FIG. 4, the superimposed image alignment unit 424 is a unit that performs alignment (position alignment) of the position of a subject in a wide-field image and the position of an object in an image of a three-dimensional model, in a superimposed image of the wide-field image and the three-dimensional model. The alignment according to the present embodiment may be manually performed according to a user operation or may be automatically performed based on the feature of the object and the subject. In the case of automatically performing the alignment, the alignment processing may be started by a user operation. Further, when the adjustment of the alignment is completed, the superimposed image alignment unit 424 may notify the completion of the position alignment by sound or display.

The superimposed image capturing unit 425 is a unit that captures a superimposed image on which alignment has been performed by the superimposed image alignment unit 424. By capturing the superimposed image, even when the viewpoint moves, the wide-field image and the image of the three-dimensional model can be prevented from being displayed misaligned, and can be displayed with enhanced visibility. Capturing a superimposed image is processing such as a so-called screenshot, and can be performed by acquiring an image from a point at which a virtual camera is arranged in the virtual space, that is, an image that can be viewed from a point at which the virtual camera is arranged, and texturing the image. Texturing refers to preparing an image to be applied on the surface of a virtual sphere for projection.

The storage unit 426 is a unit that controls the operation of the HDD 43 of the PC 12 and stores various information. The storage unit 426 according to the present embodiment can store, for example, a wide-field image, data of a three-dimensional model, and a superimposed image.

A functional unit included in the HMD 10 is described below. The image display unit 401 is an image display control unit that controls the operation of the display 22 and controls the display of an image. The image display unit 401 according to the present embodiment can display an image of a three-dimensional virtual space. The image display unit 401 is also configured as a unit that acquires various images such as a wide-field image, data of a three-dimensional model, a superimposed image, and a captured image, and controls projection display of the acquired various images. The various images displayed by the image display unit 401 can be acquired from, for example, the PC 12 or the imaging device 14. The image display unit 401 according to the present embodiment can acquire display data on which alignment has been performed by the superimposed image alignment unit 424 and project and display the display data on the display 22.

A functional unit included in the imaging device 14 is described below. The wide-field image capturing unit 441 is a unit that captures a wide-field image by the two image sensors 145A and 145B. A wide-field image captured by the wide-field image capturing unit 441 is provided to the PC 12 via, for example, the network 15, a communication cable, or various storage media. The wide-field image may be provided from the imaging device 14 to the PC 12 may be performed in real time or may be temporarily stored in the imaging device 14 and then transmitted to the PC 12.

The software configuration described above corresponds to functional units. Each of the functional units is implemented by the CPU 210 executing a program of the present embodiment to cause corresponding one or more of the hardware components to function. In any one of the embodiments, all of the functional units may be implemented by software, hardware, or a combination of software and hardware.

Further, all of the above-described functional units do not necessarily have to be configured as illustrated in FIG. 4. For example, in another preferred embodiment, each functional unit may be implemented by cooperation of devices. Further, for example, the image display unit 401 included in the HMD 10 in FIG. 4 may be included in the PC 12.

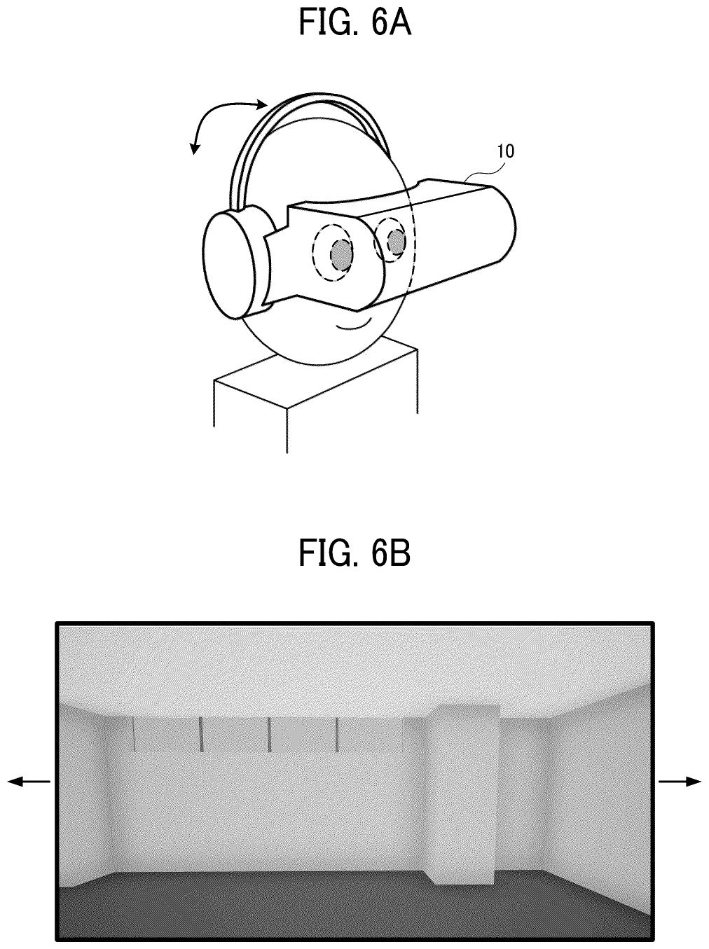

FIG. 6A is a diagram illustrating the HMD 10 worn by a user on his or her head, and FIG. 6B is a diagram illustrating an image of a three-dimensional virtual space displayed on the HMD 10 and visually recognized by the user in FIG. 6A.

The display area of the image of the three-dimensional virtual space displayed on the HMD 10 changes according to the movement of the head of the user wearing the HMD 10. For example, when the user moves his or her head to the left or right as indicated by the arrow in FIG. 6A, the displayed area in the three-dimensional space also moves to the left or right as indicated by the arrow in FIG. 6B. In substantially the same manner, the display area can be also moved up and down in conjunction with the movement of the user's head.

The display area can be operated by the controller 11 to enlarge or reduce the display area or change the viewpoint position.

The display screen illustrated in FIG. 6B is an example and does not limit the embodiment. The display screen may include other objects than those illustrated in FIG. 6B, and may include various display objects such as icons, buttons, and cursors for performing operations on the screen display.

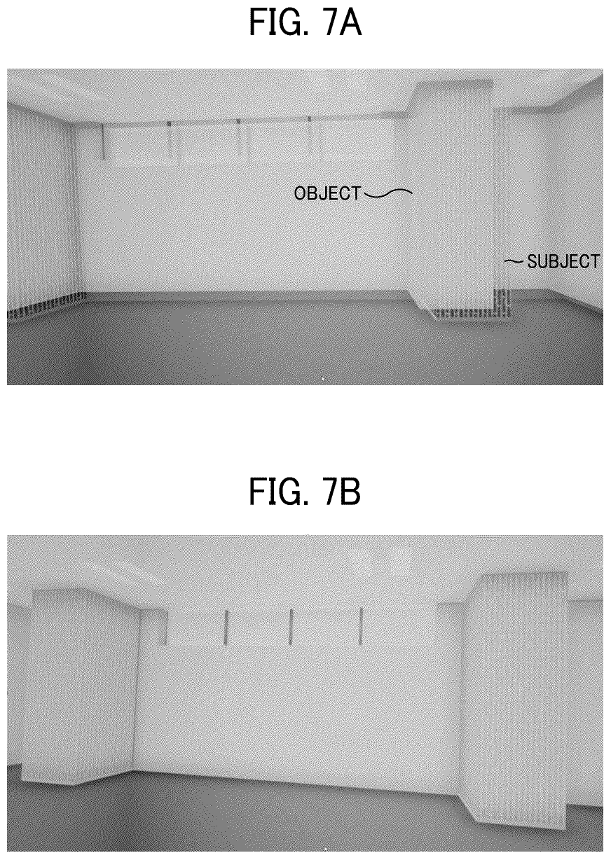

FIGS. 7A and 7B are diagrams each illustrating an example of a superimposed image viewed from the inside of a virtual sphere according to the present embodiment. A description referring to FIG. 7 is given below also by referring to FIGS. 5A to 5C as appropriate. A superimposed image in the present embodiment to be described is an image in which a virtual sphere on which a wide-field image is projected is arranged in a three-dimensional virtual space represented by three-dimensional model data. However, the embodiment is not limited thereto, and for example, an image in which a virtual sphere on which an image of three-dimensional model data is projected is arranged in a three-dimensional virtual space of a wide-field image may be used as a superimposed image. Further, an image in which a three-dimensional model with adjustable transparency is arranged in a wide-field image may be used as the superimposed image.

A case of the configuration as illustrated in FIG. 5C in which the virtual sphere (see FIG. 5B) onto which the wide-field image is projected is arranged in the three-dimensional virtual space (see FIG. 5A) represented by the three-dimensional model data is described below. The user wearing the HMD 10 can move the position of the viewpoint in the three-dimensional virtual space by operating the controller 11. When the user performs an operation for moving the position of the viewpoint in the three-dimensional virtual space and the position of the viewpoint enters the inside of the virtual sphere, the user can view both the three-dimensional model and the wide-field image. At this time, the wide-field image projected on the virtual sphere is displayed in a transparent manner, and thus the user can simultaneously view the wide-field image and the image of the three-dimensional model on a single display screen in the HMD 10.

FIG. 7A illustrates a superimposed image viewed from the inside of the virtual sphere. In FIG. 7A, the virtual sphere on which the wide-field image is projected is displayed with constant transparency. In the example illustrated in FIG. 7A, a subject of the wide-field image and an object of the three-dimensional model that represent a column are displayed. In FIG. 7A, for example, the position and the angle of the virtual sphere are not appropriate, and the subject and the object representing the same column are displayed misaligned accordingly. When the user compares the three-dimensional model with the wide-field image using this superimposed image with low visibility, the user has difficulty to perform appropriate comparison.

To cope with this, the user can adjust the display by operating the HMD 10 and the controller 11 so that the subject in the wide-field image and the object of the three-dimensional model corresponding to the subject overlap each other. The display can be adjusted by adjusting the position and angle of the virtual sphere, and the display size.

When the user performs an operation on the superimposed image and adjusts the wide-field image and the three-dimensional model so as to overlap each other, the display as illustrated in FIG. 7B is obtained. That is, when the user performs an appropriate adjustment, the subjects such as the column, the window, the floor, the ceiling, and the wall in the wide-field image and the corresponding objects such as the column, the window, the floor, the ceiling, and the wall of the three-dimensional models are displayed in an overlapping manner as illustrated in FIG. 7B. In the embodiment described below, adjusting the subject and the object to be displayed in an overlapping manner as illustrated in FIG. 7B is referred to as “alignment (position alignment)”.

As illustrated in FIG. 7B, the superimposed image in which the subject of the wide-field image and the object of the three-dimensional model are superimposed is displayed, and thus the user can easily compare both images. For example, when there is a building constructed based on a three-dimensional model and the user checks whether the internal structure of the building is constructed according to the three-dimensional model, the user can easily recognize the difference between the three-dimensional model and the actual building by checking the superimposed image on which alignment has been performed as illustrated in FIG. 7B.

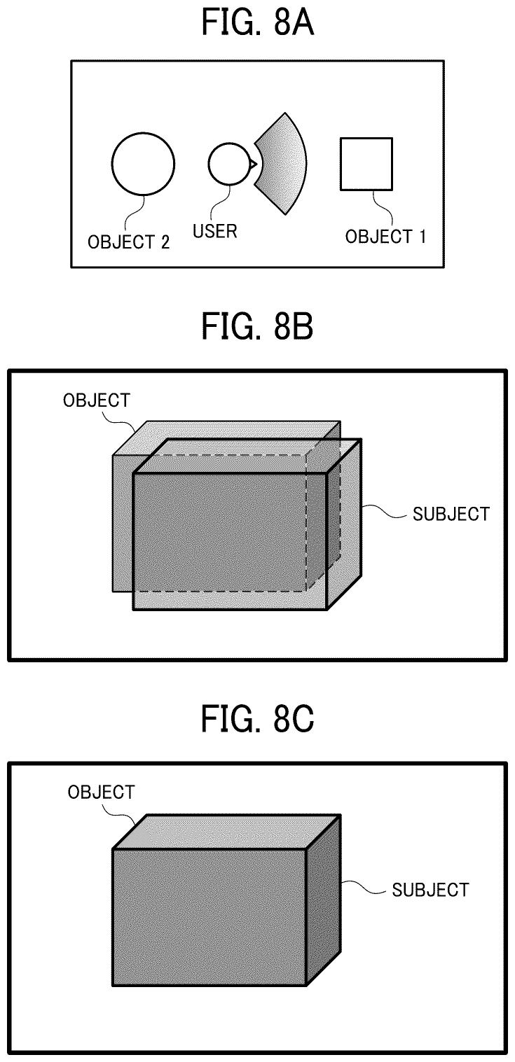

The alignment according to the present embodiment is described below. FIGS. 8A to 8C are diagrams illustrating an example of alignment according to the present embodiment. For example, as illustrated in FIG. 8A, a case in which the user is looking at an object 1 with a cube shape in a superimposed image of a three-dimensional virtual space including the object 1 and an object 2 with a spherical shape.

In the case of FIG. 8A, when alignment is not performed, the subject and the object are displayed misaligned as illustrated in FIG. 8B. Accordingly, the user has difficulty to compare the wide-field image with the three-dimensional model.

To cope with this, the user performs an operation on the superimposed image by using, for example, the HMD 10 or the controller 11, and perform alignment to align the position of the subject and the position of the object. The alignment can be performed by changing the coordinates of the virtual sphere (for example, matching the viewpoint position with the center position of the virtual sphere), rotating the virtual sphere (for example, rotating the virtual sphere in the yaw, roll, or pitch direction), or enlarging or reducing the wide-field image (for example, changing the diameter of the virtual sphere).

When the display is appropriately adjusted and alignment is performed, a superimposed image as illustrated in FIG. 8C is displayed on the HMD 10. In the superimposed image illustrated in FIG. 8C, the object 1 of the three-dimensional model and the object 1 included in the wide-field image are displayed in an overlapping manner.

Accordingly, the user can easily compare the three-dimensional model with the wide-field image. As a result, if there are some defects (for example, dimension errors or a shape discrepancies) for the object 1 in the wide-field image, the user can easily recognize the defect.

Even when alignment is performed as illustrated in FIG. 8C, if the viewpoint position or the gaze direction is moved after the alignment, misalignment may occur between the object and the subject displayed in the three-dimensional virtual space. Accordingly, for example, in a case where the internal structure of a building is checked, if the user moves the gaze to check another object after the alignment is performed with reference to the column, the object and the subject are misaligned, and it is difficult to appropriately check the internal structure.

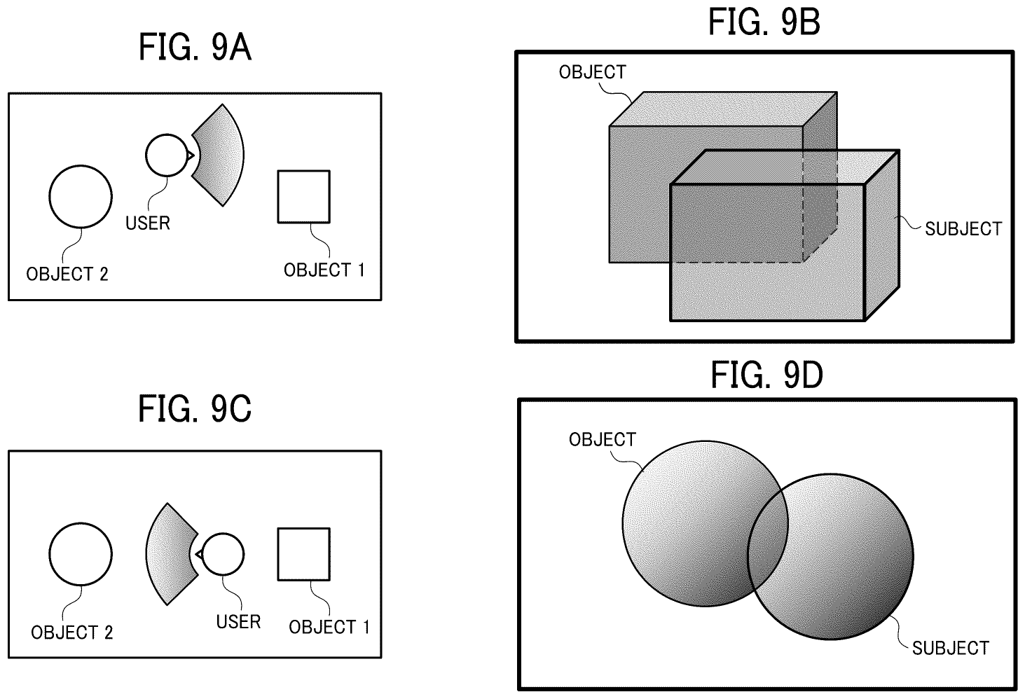

The viewpoint movement after the alignment is described later with reference to FIGS. 9A to 9D. FIGS. 9A to 9D are diagrams illustrating an example of a case where a viewpoint is moved after alignment according to the related art. FIGS. 9A to 9D illustrate cases where the viewpoint position or the gaze direction is moved according to a user operation after alignment is performed as illustrated in FIG. 8C.

FIG. 9A illustrates an example in which the viewpoint position of the user is moved after the position adjustment is performed as illustrated in FIG. 8C in the three-dimensional virtual space illustrated in FIG. 8A. That is, the user in FIG. 9A views the object 1 with a cube shape as in FIG. 8A, but from a position to which the viewpoint position in FIG. 8A has been moved. In this case, even when alignment is performed as illustrated in FIG. 8C, the wide-field image projected on the virtual sphere and the image of the three-dimensional model of the three-dimensional virtual space are misaligned by the subsequent movement of the viewpoint position, and thus the subject and the object are displayed misaligned as illustrated in FIG. 9B.

Further, FIG. 9C illustrates an example in which the viewpoint position of the user is moved after alignment is performed as illustrated in FIG. 8C in the three-dimensional virtual space illustrated in FIG. 8A. That is, the user in FIG. 9A moves the viewpoint for displaying the image on the HMD 10 from the direction of the object 1 to the direction of the object 2. In this case, even when alignment is performed as illustrated in FIG. 8C, the wide-field image projected on the virtual sphere and the image of the three-dimensional model of the three-dimensional virtual space are misaligned by the subsequent movement of the viewpoint position (for example, even if the viewpoint position is simply rotated in the gaze direction, the viewpoint position may be moved by the movement of the head), and thus the subject and the object are displayed misaligned as illustrated in FIG. 9B and FIG. 9D.

As described above, even when alignment is appropriately performed, if the viewpoint position is moved even slightly after the alignment, misalignment occurs, and the object and the subject are displayed misaligned, and thus the visibility of the superimposed image is reduced. To cope with this, the display system 1 according to the present embodiment captures the superimposed image as a wide-field image in which alignment has been just performed and the object and the subject are aligned, and projects the captured image onto the virtual sphere to display the captured image on the HMD 10. Thus, the image maintaining the aligned state is displayed on the HMD 10, and even if the viewpoint position is moved thereafter, the misalignment between the object and the subject does not occur, and appropriate comparison can be easily performed. By continuously performing the capture processing, a captured image following the movement of the viewpoint can be projected and displayed.

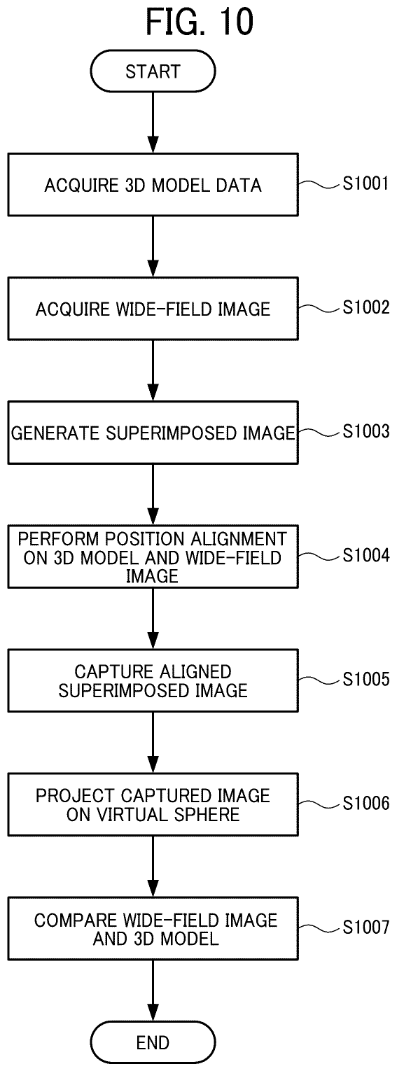

A process executed in the present embodiment is described with reference to FIG. 10. FIG. 10 is a flowchart illustrating a process performed by the display system 1 according to the present embodiment. FIG. 10 illustrates a process performed when a wide-field image is compared with a three-dimensional model corresponding to a space in which the wide-field image is captured. The display system 1 starts the process from Step S1000.

In Step S1001, the three-dimensional model data acquisition unit 421 acquires three-dimensional model data. The acquired three-dimensional model data is output to the superimposed image generation unit 423. In Step S1002, the wide-field image acquisition unit 422 acquires a wide-field image. The wide-field image acquired by the wide-field image acquisition unit 422 is output to the superimposed image generation unit 423. The processing of Step S1001 and Step S1002 does not necessarily have to be performed in the order illustrated in FIG. 10, and for example, may be performed in the reverse order of FIG. 10, or the two processing of Step S1001 and the processing Step S1002 may be performed in parallel.

In Step S1003, the superimposed image generation unit 423 generates a superimposed image from the three-dimensional model data and the wide-field image acquired in Step S1001 and Step S1002. In the present embodiment, the superimposed image generation unit 423 generates a superimposed image by arranging a virtual sphere onto which the wide-field image is projected in a three-dimensional virtual space that is based on the three-dimensional model data. The generated superimposed image is output to a display device such as the HMD 10 and displayed by various display units, thereby allowing the user to view the superimposed image.

Then, in Step S1004, the superimposed image alignment unit 424 performs alignment to align the position of the object included in the three-dimensional model and the subject included in the wide-field image. The alignment may be performed according to a user operation while the user views the superimposed image, or may be automatically performed based on the feature of the object. The alignment can be performed by adjusting parameters such as the coordinate position, angle, and size of the virtual sphere. For example, when the alignment is manually performed according to a user operation, the amount of movement may be adjusted while referring to an arrow (vector) indicating the movement from the original position, or the amount of movement may be adjusted by referring to a coordinate position indicated by a numerical value. Further, when the alignment is performed, the transparency may be adjusted during the movement to facilitate viewing or visibility.

After the alignment is performed in Step S1004, the superimposed image capturing unit 425 captures a superimposed image in Step S1005. The captured superimposed image (in the following description, referred to as “captured image”) is a wide-field image also with a solid angle of 4π steradians. The generated captured image is output to the HMD 10, but may be stored in the storage unit 426.

Subsequently, in Step S1006, the image display unit 401 projects the captured image onto the virtual sphere and displays the captured image on the HMD 10. This allows the user to compare the wide-field image with the image of the three-dimensional model by viewing the captured image in Step S1007.

Then, in Step S1008, the display system 1 ends the process.

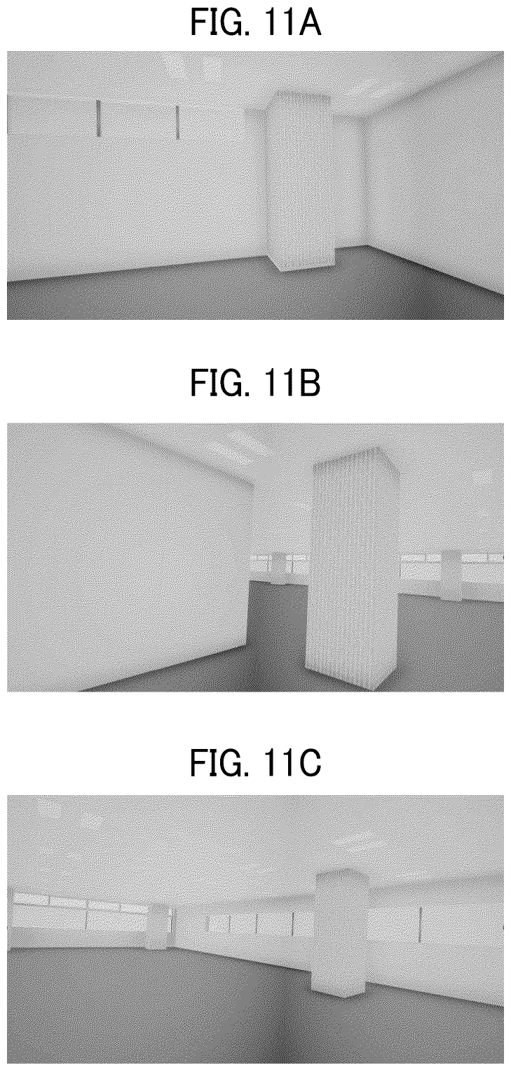

FIG. 11 is a diagram illustrating an example of displaying a captured image according to the present embodiment. FIG. 11 illustrates the example of displaying an image captured after the alignment is performed on the superimposed image as illustrated in FIG. 7B

Images illustrated in FIGS. 11A to 11C are captured after alignment and obtained by moving the viewpoint. As illustrated in FIGS. 11A to 11C, even when the viewpoint moves, the image is projected and displayed, maintaining the alignment of the positions of the object and the subject as in FIG. 7B.

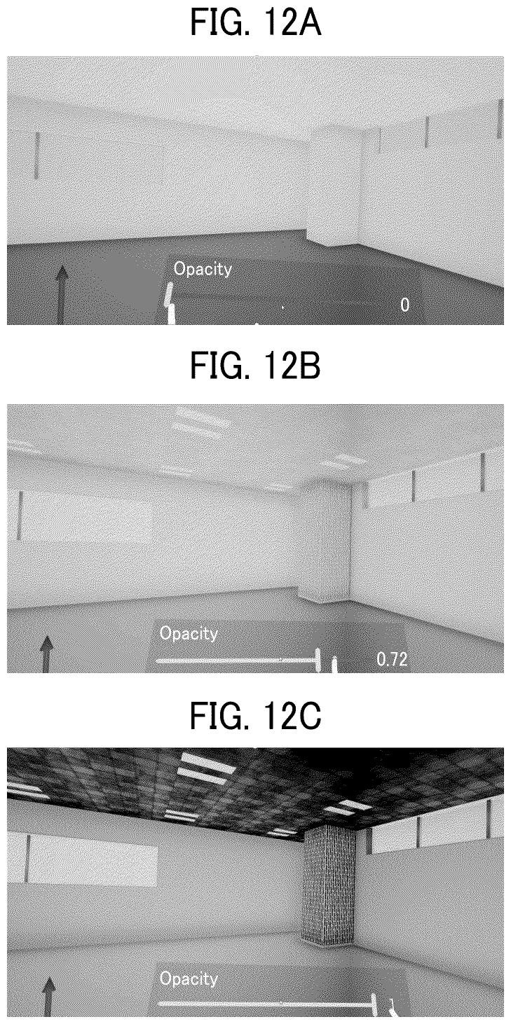

In the present embodiment, the transparency of the image projected on the virtual sphere is adjustable to facilitate comparison between the image of the three-dimensional model and the wide-field image. FIGS. 12A to 12C are diagrams illustrating an example of adjusting (changing) the transparency of an image projected on a virtual sphere according to the present embodiment. FIG. 12A is an example of a superimposed image in a case where the transparency of the virtual sphere is 100%, FIG. 12B is an example of a superimposed image in a case where the transparency of the virtual sphere is 28%, and FIG. 12C is an example of a superimposed image in a case where the transparency of the virtual sphere is 0%.

As illustrated in FIG. 12A, when the transparency of the virtual sphere is set to 100%, the wide-field image projected on the virtual sphere is not displayed, and the image of the three-dimensional model alone is displayed.

As illustrated in FIG. 12B, when the transparency of the virtual sphere is set to 28%, the wide-field image projected on the virtual sphere is displayed in a transparent manner and is superimposed on the image of the three-dimensional model. In FIG. 12B, the patterns of the column and the ceiling included in the wide-field image are displayed relatively unclearly.

As illustrated in FIG. 12C, when the transparency of the virtual sphere is set to 0%, the wide-field image projected on the virtual sphere is displayed, and the image of the three-dimensional model is not displayed. Accordingly, the patterns of the column and the ceiling included in the wide-field image are clearly displayed.

The transparency is adjustable according to a user operation. Accordingly, the user can easily recognize the difference between the three-dimensional model and the wide-field image by viewing the superimposed image in which the transparency is adjusted.

The adjustment (change) of the transparency as illustrated in FIGS. 12A to 12C can be performed on the virtual sphere included in the captured image. That is, the captured image according to the present embodiment includes the three-dimensional virtual space and the virtual sphere that are aligned, and by changing the transparency of the virtual sphere included in the captured image, the misalignment of objects and to easily compare the wide-field image and the image of the three-dimensional model can be eliminated.

As described above, according to the present embodiment, the captured image and the three-dimensional model can be appropriately superimposed and displayed.

In related art, when an image to be superimposed on a three-dimensional computer graphics image is a spherical image, when the viewpoint position for displaying the image moves, misalignment of the position of an object in the image of a three-dimensional model and the position of a subject in the spherical image occurs. Accordingly, the visibility in the case of comparing an actual object and a three-dimensional model is reduced, and there is difficulty in performing appropriate comparisons.

To cope with this, a technique for displaying a spherical image and a three-dimensional model without misaligned even when a viewpoint for displaying the image is moved has been desired.

With the configuration described in the one or more embodiments, a captured image and an image of a three-dimensional model can be appropriately superimposed and displayed.

Each of the functions of the embodiments of the present disclosure can be implemented by a device-executable program written in, for example, C, C++, C#, and JAVA. The program according to an embodiment of the present disclosure can be stored in a device-readable recording medium to be distributed. Examples of the recording medium include a hard disk drive, a compact disk-read-only memory (CD-ROM), a magneto-optical disk (MO), a digital versatile disk (DVD), a flexible disk, an electrically erasable programmable read-only memory (EEPROM), and an erasable programmable read-only memory (EPROM). The program can be transmitted over a network in a form executable with another computer.

Although several embodiments of the present disclosure have been described above, embodiments of the present disclosure are not limited to the above-present embodiments, and various modifications may be made without departing from the spirit and scope of the present disclosure that can be estimated by the skilled person. Such modifications exhibiting functions and effects of the present disclosure are included within the scope of the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

1. A system, comprising circuitry configured to:
generate display data in which a three-dimensional model and an image captured are superimposed;
perform alignment to align a position of an object included in the three-dimensional model and a position of a subject included in the image;
capture a superimposed image in which the position of the object included in the three-dimensional model and the position of the subject included in the image are aligned by the alignment; and
project the captured superimposed image on a virtual sphere for display.

2. The system of claim 1, wherein
the circuitry is configured to generate an additional superimposed image in which the virtual sphere on which the captured superimposed image is projected is arranged in a three-dimensional virtual space of the three-dimensional model.

3. The system of claim 1, wherein
the circuitry is configured to perform the alignment according to a user operation.

4. The system of claim 1, wherein
the circuitry is configured to detect the object included in the three-dimensional model and the subject corresponding to the object to perform the alignment.

5. The system of claim 1, wherein
the captured superimposed image projected on the virtual sphere has adjustable transparency.

6. A method, comprising:
generating display data in which a three-dimensional model and an image captured are superimposed;
performing alignment to align a position of an object included in the three-dimensional model and a position of a subject included in the image; and
capturing a superimposed image in which the position of the object included in the three-dimensional model and the position of the subject included in the image are aligned by the alignment,
wherein the captured superimposed image is to be projected on a virtual sphere for display.

7. A display device, comprising circuitry configured to:
acquire a captured superimposed image in which a position of an object included in a three-dimensional model and a position of a subject included in an image are aligned; and
project and display the captured superimposed image on a display.
